(19) United States
(12) Patent Application Publication
(10) Pub. No.: US 2006/0179901 A1
(43) Pub. Date: Aug. 17, 2006

(54) System for preventing driving while intoxicated

(76) Inventor: Lawrence J. Schlitt, Rancho Santa Fe, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 11/061,710

(22) Filed: Feb. 17, 2005

(51) Int. Cl. B60R 25/02

(52) U.S. Cl. 70/209

(57) ABSTRACT

A drunk driving prevention system includes a steering wheel locking device. The steering wheel locking device may include a first bar including a steering wheel engagement member, a second bar, including a steering wheel engagement member, longitudinally movably mounted with respect to the first bar, and a lock operable to fix the first and second bars longitudinally with respect to each other. A lock cover is movably mounted with respect to said lock. The lock cover is movable between an open position that permits access to the lock and a closed position that prevents access to the lock. A latch is operable to hold the lock cover in the closed position. A breath alcohol measuring device is coupled to release the latch when a driver's breath alcohol level is determined to be less than a predetermined level.

### BACKGROUND OF THE INVENTION

The present invention relates to the field of automobile antitheft and security systems, and more particularly to an automobile antitheft system that includes a system for preventing driving while intoxicated.

Driving while intoxicated, particularly with alcohol, is a serious problem. Every year, thousands of lives are lost due to drunk driving. The loss of life from drunk driving also diminishes the lives of the friends and relatives of those lost. Moreover, tens of thousands of people every year have their lives ruined due to drunk driving, either as a result of having caused an accident or having been arrested for driving while intoxicated.

Although many drunk drivers are chronic alcoholics who become intoxicated knowing that they will drive drunk, probably the majority of people involved in accidents or arrested for driving while intoxicated are social drinkers who would never think of driving while intoxicated. Such people may go to social events planning not to overindulge, but during the course of the event, they may lose track of how much they have had to drink and become intoxicated. Their intoxication impairs their judgment and they may attempt to drive.

It is an object of the present invention to provide a simple device with which a person may make his or her car incapable of being driven while the person is intoxicated.

### BRIEF SUMMARY OF THE INVENTION

The present invention provides a drunk driving prevention system. An embodiment of the system of the present invention includes a steering wheel locking device. The steering wheel locking device may include a first bar including a steering wheel engagement member, a second bar, including a steering wheel engagement member, longitudinally movably mounted with respect to the first bar, and a lock operable to fix the first and second bars longitudinally with respect to each other. The embodiment of the present invention further includes a lock cover movably mounted with respect to said lock. The lock cover is movable between an open position that permits access to the lock and closed position that prevents access to the lock. A latch is operable to hold the lock cover in the closed position. A breath alcohol measuring device is coupled to release the latch when a driver's breath alcohol level is determined to be less than a predetermined level.

### BRIEF DESCRIPTION OF THE DRAWINGS

FIG. 1 is a perspective view of an example of a system according to the present invention.

FIG. 2 is a top view of a portion of a system according to the present invention.

FIG. 3 is a partial sectional view taken generally along line 3-3 of FIG. 2.

FIG. 4 is a partial sectional view showing details of a device for preventing access to an antitheft system lock.

FIG. 5 is an exploded view of an example of an antitheft device that may be used according to the present invention.

FIG. 6 is a side view showing details of an antitheft system lock.

FIG. 7 is sectional view taken along line 7-7 of FIG. 6.

FIG. 8 is a sectional view taken along line 8-8 of FIG. 6.

FIG. 9 is a block diagram of an embodiment of a system according to the present invention.

FIG. 10 is a flowchart of the operation of an embodiment of the present invention.

### DETAILED DESCRIPTION OF THE INVENTION

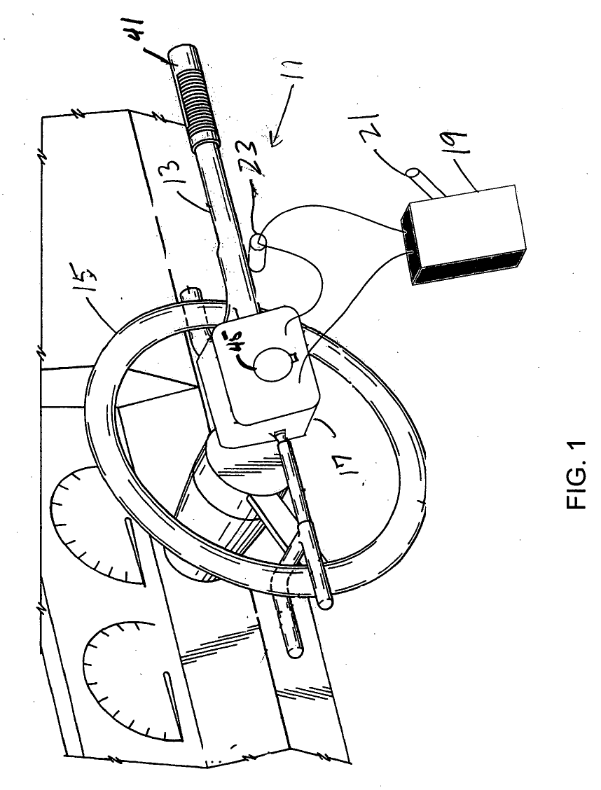

Referring now to the drawings, and first to FIG. 1, an embodiment of a drunk driving prevention system according to the present invention is designated generally by the numeral 11. System 11 includes an external steering wheel locking device 13, which will be described in detail hereinafter. Steering wheel locking device 13 may be of the type known as “The Club”™ marketed by Winner International LLC. As is well known and shown in FIG. 1, steering wheel locking device 13 may be removably mounted on an automobile steering wheel 15.

System 11 includes a lock cover assembly 17 that will be described in detail hereinafter. A breath alcohol testing device 19 is electrically coupled to lock cover assembly 17. Breath alcohol testing device 19 may be one of many commercially available devices. Alcohol is a drug that affects the central nervous system. Impairment from alcohol intoxication is legally defined by blood alcohol levels. It has been observed that most people showed measurable mental impairment at around 0.05% blood alcohol concentration (BAC). Above this level it has been found that motor functions deteriorate progressively with increased blood alcohol concentrations. Most states define alcohol intoxication to occur at a BAC greater than 0.08%.

While blood tests are highly accurate and offer the ability to test the same sample several times, if the sample is maintained properly, there are several disadvantages associated with measuring alcohol intoxication with blood tests. These disadvantages include the need for trained medical personnel to collect a blood sample, the sample collection is invasive, the analysis requires precise procedures by trained lab technicians, the results are not immediately available, and the overall process is costly.

A good alternative to blood testing is breath alcohol testing, which takes advantage of the fact that alcohol is found in the deep lung breath in proportion to the alcohol found in the blood. A blood:breath ratio of 2100:1 has been widely accepted for use in computing blood alcohol concentration from breath. This means that 2,100 milliliters of deep lung air will contain the same amount of alcohol as one milliliter of blood. Breath testing instruments are manufactured to capture a sample of alveolar breath for analyses. Current breath analytical instruments are low cost, highly accurate, rapid analytical systems that simply and painlessly collect a sample and calculate a result. Currently available breath alcohol testing devices employ any of several technologies, such as gas chromatography, infrared spectroscopy, semiconductor sensors, such as tin oxide sensors, and electrochemical analyzers, such as fuel cells.

Breath alcohol testing device 19 includes a tube 21 into which a person blows a sample of deep lung air. As is well known to those skilled in the art, breath alcohol testing device 19 includes a device and circuits for measuring and calculating breath alcohol level (not shown). Device 19 is adapted to output a signal to assembly 17 when the sampled deep lung air is determined to have a breath alcohol content less than a predetermined level. For example, Device 19 may output a signal when the measured breath alcohol content corresponds to a blood alcohol content of less than 0.08%. Device 19 typically includes circuitry for determining if the sample is human breath. Device 19 may include means for disabling itself for a predetermined time after a failed test.

System 11 may include an external power source, such as a cigarette lighter plug 23, for providing electric power to breath alcohol testing device 19 and lock cover assembly 17. Alternatively, breath alcohol testing device 19 and lock cover assembly 17 may each have their own internal power supply, such as batteries. While breath alcohol testing device 19 and lock cover assembly 17 are illustrated as being separate devices, they may be combined into a single structure.

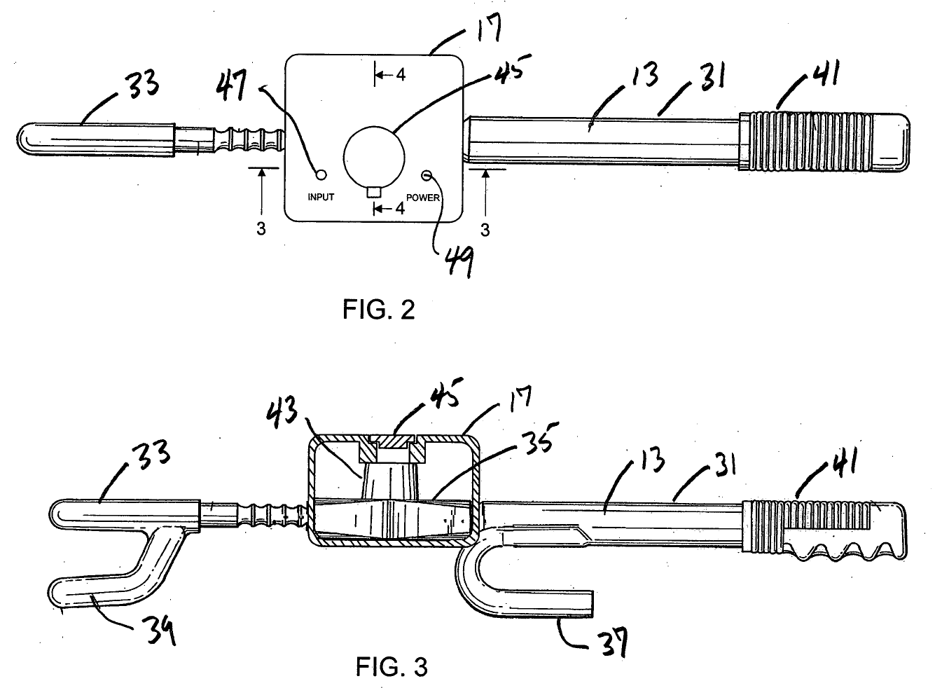

Referring now to FIGS. 2 and 3, there are shown details of steering wheel locking device 13 and lock cover assembly 17. Steering wheel locking device 13 includes an elongated first bar 31, an elongated second bar 33 that is dimensioned to move in telescopic fashion within first bar 31, and a locking assembly 35. Steering wheel locking device 13 includes hooks 37 and 39 for engaging diametrically opposed portions of steering wheel 15, as shown in FIG. 1. Hook 37 is connected to first bar 31. Hook 39 is connected to second bar 33. First bar 31 includes at its end opposite hook 37 a handle 41. First bar 31 extends outwardly from hook 37 a distance so that when device 13 is locked on a steering wheel 15, the outer end of first bar 31 will engage structure inside the automobile and prevent further turning on the steering wheel 15.

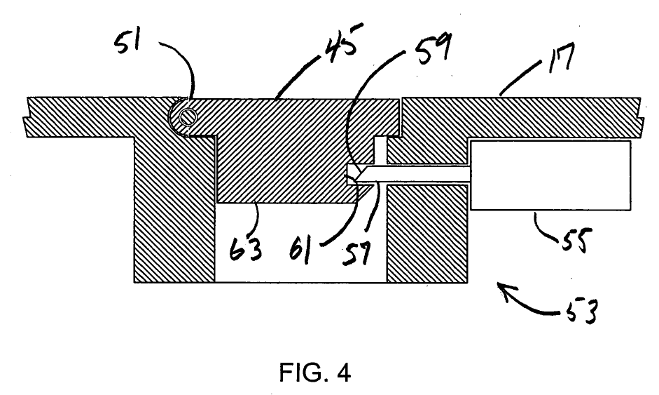

As will be described in detail hereinafter, locking assembly 35 includes a lock boss 43, which contains a lock (shown in FIG. 4). Lock cover assembly 17 is a box-like structure mounted around locking assembly 35. Lock cover assembly 17 includes a door 45 positioned over lock boss 43. Lock cover assembly 17 may include an input 47 for receiving a signal from breath alcohol testing device 19 (FIG. 1) and a power input 49 to receive power from cigarette lighter plug 23 (FIG. 1). As will be apparent to those skilled in the art, lock cover assembly 17 may include suitable wiring, which has not been illustrated, for purposes of clarity.

Referring now to FIG. 4, door 45 is mounted to lock cover assembly 17 by means of a hinge arrangement 51. Door 45 is shown in a closed position. Hinge arrangement 51 may be spring loaded in order to bias door 45 toward an open position (not shown). Door 45 is held in its closed position by latch 53. Latch 53 includes a spring loaded solenoid 55 and a rod 57. The tip 59 of rod 57 engages a slot 61 in door 45. Since latch 53 is spring loaded, tip 59 of rod 57 will remain engaged with slot 61 of door 45 until solenoid 55 is energized to retract rod 57. When rod 57 is retracted, door 45 is urged to its open position by spring loaded hinge 51. When solenoid 55 is de-energized, rod 57 returns to its extended position. As shown in FIG. 4, tip 59 of rod 57 may be beveled. The bottom end 63 of door 45 may also be beveled. The bevels of rod 57 and door 45 aid in pushing rod inwardly when door 45 is moved to its closed position.

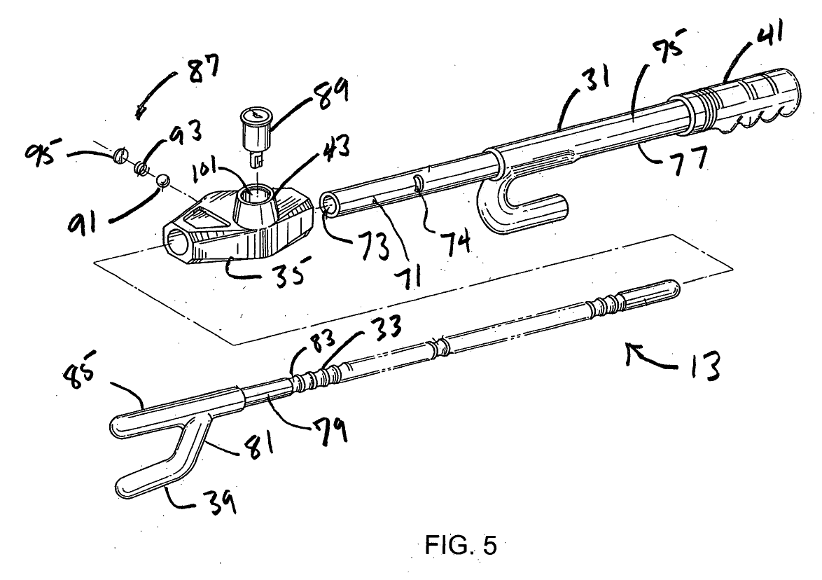

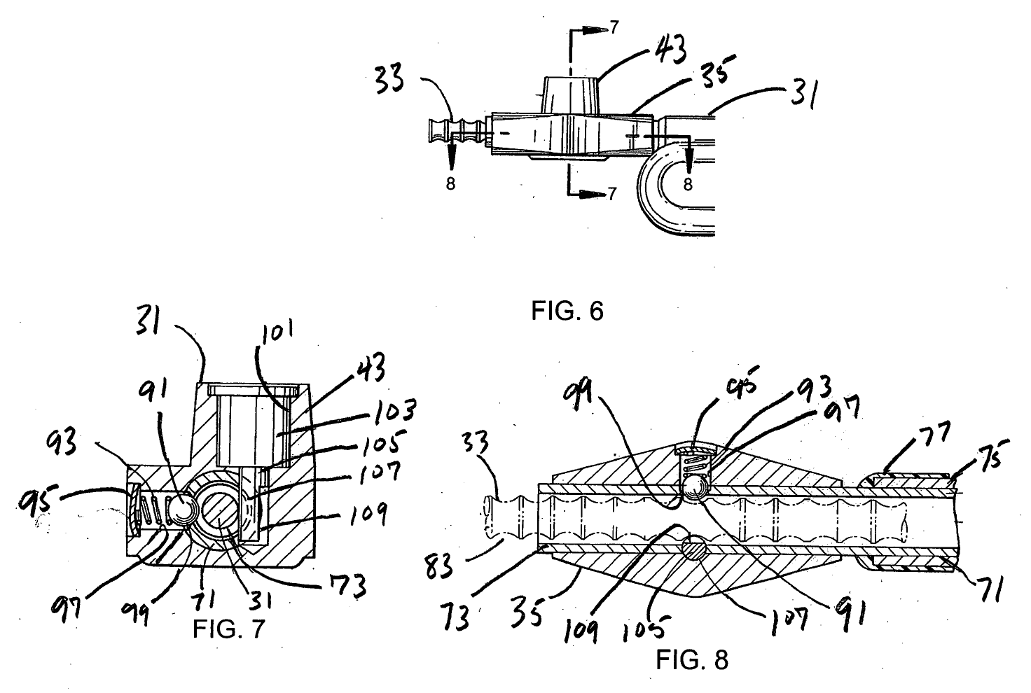

Details of steering wheel locking device 13 are illustrated in FIGS. 5-8. FIG. 5 shows an exploded view of steering wheel locking device 13. Steering wheel locking device 13 includes an elongated first bar 31, an elongated second bar 33 that is dimensioned to move in telescopic fashion within first bar 31. Hooks 37 and 39 are connected to first bar 31 and second bar 33, respectively.

First bar 31 includes an elongated tube 71 having a circular cross-section. Tube 71 defines a central passage 73 of circular cross-section. A lateral opening 74 is formed in tube 71 to intersect central passage 73. Tube 71 is surrounded by an outer sleeve 75 to provide a double-walled section. U-shaped hook 37 is fixedly secured to sleeve 75 adjacent tube 71. Tube 71 and sleeve 75 comprise lengths of standard structural steel pipe welded together. Hook 37 is a length of standard pipe bent or otherwise formed into a U-shaped configuration and welded to sleeve 75. A durable plastic coating 77 may be provided over sleeve 75 and hook 37 to provide a nonabrasive surface. A handle or grip 41 is secured to the free end of sleeve 75.

Second bar 33 includes an elongated rod 79 of circular cross-section. The outer diameter of rod 79 is dimensioned slightly less than the diameter of passage 73 in first bar 31 to enable rod 79 to move freely in telescopic fashion in first bar 31. A generally L-shaped member 81 is fixedly secured to the end of rod 79 to form hook 39 which opens opposite hook 37 for engagement with a diametrically opposed portion of steering wheel 15 (FIG. 1). Annular grooves 83 are provided along a major portion of rod 79. Grooves 83 are generally semi-circular and are axially spaced along rod 79. The hook end of second bar 33 may be provided with a plastic coating 85 similar to that provided on first bar 31.

A locking assembly 35 is affixed to tube 71. Locking assembly 35 contains a locating assembly 87 and a lock 89. Locating assembly 87 includes a spherical bearing 91 and a biasing spring 93 disposed within a bore 97 in locking assembly 35. Bore 97 communicates with passage 73 as shown in FIGS. 7 and 8. Bore 97 registers with opening 74 of tube 71. An annular flange 99 is provided at the end of bore 97 to restrict complete access of bearing 91 into passage 73. Bearing 91 and spring 93 are maintained in bore 97 by retainer 95. Spring 93 is confined within bore 97 in compression such that bearing 91 is biased towards, and partially exposed in, passage 73.

Lock 89 is retained in a bore 101 formed in boss 43 of locking assembly 35. Lock 89 comprises a conventionally known key lock barrel 103 and a locking member 105. Locking member 105 includes an arcuate surface 107 of a diameter generally matching the semi-circular grooves 83 in rod 79, and a flat surface 109. An appropriate key (not shown) inserted into lock 89 can be operated to rotate locking member 105 with respect with respect to lock barrel 103 between a locked position shown in FIG. 7 and an unlocked position shown in FIG. 8. In the locked position, arcuate surface 107 engages a groove 83 in second bar 33, thereby locking first and second bars 31 and 33 with respect to each other. In the unlocked position, flat surface 109 is clear of second bar 33, thereby allowing first and second bars 31 and 33 to move longitudinally with respect to each other.

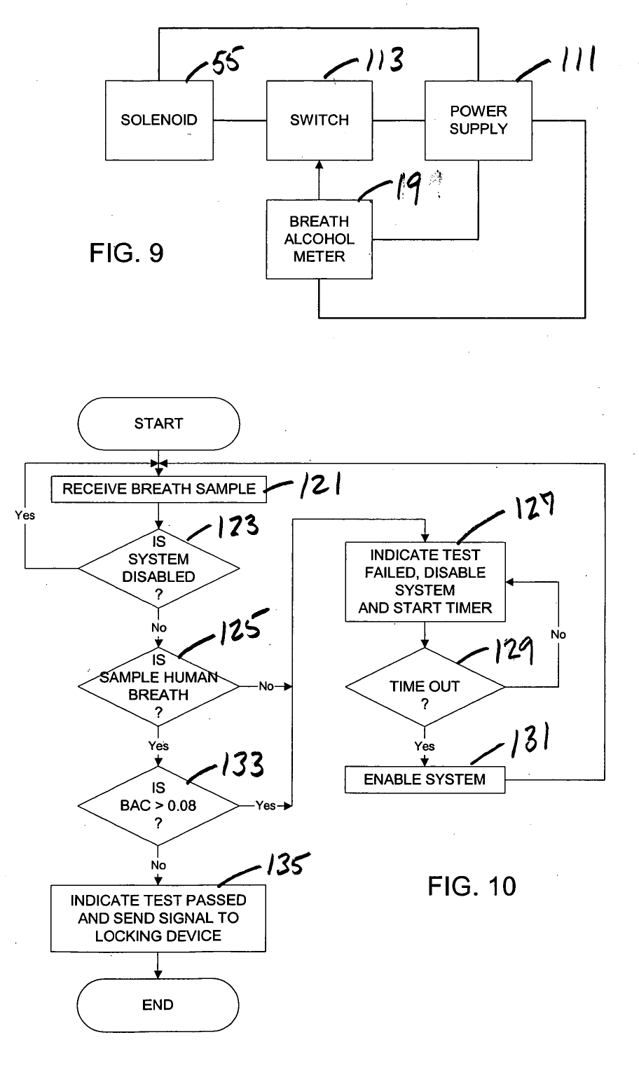

A high level electrical block diagram of an embodiment of the present invention is illustrated in FIG. 9. The electrical components generally include a power supply 111, a breath alcohol testing device 19, a switch 113, and a solenoid 55. Power supply 111 may be a car battery, as described with respect to FIG. 1, or a separate battery or batteries. While a single power source 111 is illustrated in FIG. 9, the system of the present invention may include separate power sources to energize solenoid 55 and breath alcohol testing device 19.

Breath alcohol testing device 19 may be any one of a number of commercially available devices as described with respect to FIG. 1. Breath alcohol testing device 19 is adapted to produce a signal that indicates a person's breath or blood alcohol level. The signal may be a numerical value, a simple binary on/off signal, or a coded code signal. Switch 113 may include an electromechanical relay or transistor electrical switch. Switch 113 is normally off or at high impedance. When switch 113 receives a signal from breath alcohol testing device 19, that indicates a driver not intoxicated, switch 113 goes to on or to low impedance, thereby energizing solenoid 55. Switch 113 may include logic circuitry for decoding the signal received from breath alcohol testing device 19.

Referring now to FIG. 10, there is shown a flowchart of the operation of an embodiment of a breath alcohol testing device. The device receives a sample at block 121. The device tests, at decision block 123, if the system is disabled. If the system is disabled, the device returns to block 121 and waits for another sample. If the system is not disabled, then the device tests, at decision block 125, if the sample is human breath. The ability to distinguish between human breath and other air sources is a standard feature of commercially available breath alcohol testing devices. If the sample is determined not to be human breath, the system indicates that the test has failed, disables the system, and starts a timer, all as indicated at block 127. The indication that the test has failed may be by means of an audible signal, a colored light, or any other suitable indicator. The system is disabled for a predetermined period of time so that the driver cannot retake the test or let a passerby take the test immediately. An example of a predetermined time is thirty minutes. The system remains disabled until the timer times out, as indicated at decision block 129. Then the system is enabled at block 131.

Returning to decision block 125, if the sample is determined to be human breath, the device determines, at decision block 133, if the driver's blood alcohol concentration is greater than 0.08%. While the device measures breath alcohol concentration, the relationship between breath alcohol concentration and blood alcohol concentration is well known. Since legal intoxication is defined with respect to blood alcohol concentration, breath alcohol testing devices typically convert measured breath alcohol concentration to an equivalent blood alcohol concentration. A blood alcohol concentration of 0.08% is used as an example; the pass/fail level may be set higher or lower.

If the driver's blood alcohol concentration is determined to be greater than 0.08%, then the test is failed and processing continues at block 127. If the driver's blood alcohol concentration is determined to be equal to or less than 0.08%, then the device indicates that the test has been passed and sends a signal to the locking device, all as indicated at block 135.

In operation, when a driver arrives at a place where he or she may be served alcohol, the driver installs the steering wheel locking device 13 on steering wheel 15, as illustrated in FIG. 1, locks lock 89, removes the key (not shown), and closes door 45. Door 45 now cannot be opened unless the driver blows a sample of deep lung breath into breath alcohol testing device 19, and the sample indicates that the driver is not intoxicated. Thus, when the driver returns to the car, he or she cannot remove the locking device from the steering wheel and operate the car unless he or she passes the breath alcohol test.

From the foregoing it may be seen that the present invention provides a relatively simple and inexpensive system for preventing a person from driving while intoxicated. The system of the present invention does not require any modification of the car. The use of the system is voluntary in the sense that a person may elect not to use the system. However, a prudent person who does not wish to drive while intoxicated may use the system in situations where the person might become intoxicated.

The present invention has been illustrated and described with reference to presently preferred embodiments. Those skilled in the art, given the benefit of this disclosure, will recognize modifications and alternative embodiments. For example, the “Club”-type device is only an example of a steering wheel locking device; those skilled in the art will recognize alternative steering wheel locking devices. Accordingly, the foregoing description is intended for purposes of illustration and not of limitation.

What is claimed is:

1. A drunk driving prevention system, which comprises:
means for locking a steering wheel;
means for determining a breath alcohol content;
means for means for preventing access to said steering wheel locking means if a breath alcohol content determined by said determining means is greater than a predetermined level.

2. The drunk driving prevention system as claimed in claim 1, wherein said means for locking said steering wheel comprises an externally mountable steering wheel locking device.

3. The drunk driving prevention system as claimed in claim 2, wherein said externally mountable steering wheel locking device includes:
a first bar including a steering wheel engagement member;
a second bar longitudinally movably mounted with respect to said first bar, said second bar including a steering wheel engagement member; and,
a lock operable to fix said first and second bars longitudinally with respect to each other.

4. The drunk driving prevention system as claimed in claim 3, wherein said means for preventing access to said steering wheel locking means if a breath alcohol content determined by said determining means is greater than a predetermined level comprises:
a lock cover movably mounted with respect to said lock, said lock cover being movable between an open position permitting access to said lock and closed position preventing access to said lock;
a latch operable to hold said lock cover in said closed position;
means for releasing said latch if a breath alcohol content determined by said determining means is equal to or less than said predetermined level.

5. The drunk driving prevention system as claimed in claim 4, including:
means for disabling for a predetermined time period said means for releasing said latch if said breath alcohol content is determined by said determining means to be greater than said predetermined level.

6. A drunk driving prevention system, which comprises:
an external steering wheel locking device, said external steering wheel locking device including a lock;
means for blocking access to said lock; and,
means for permitting access to said lock if a driver's breath alcohol content is less than a predetermined level.

7. The drunk driving prevention system as claimed in claim 6, wherein said external steering wheel locking device comprises:
a first bar including a steering wheel engagement member; and,
a second bar longitudinally movably mounted with respect to said first bar, said second bar including a steering wheel engagement member.

8. The drunk driving prevention system as claimed in claim 7, wherein said lock is operable to fix said first and second bars longitudinally with respect to each other.

9. The drunk driving prevention system as claimed in claim 6, wherein said means for blocking access to said lock comprises:
a lock cover movably mounted with respect to said lock, said lock cover being movable between an open position permitting access to said lock and closed position preventing access to said lock; and,
a latch operable to hold said lock cover in said closed position.

10. The drunk driving prevention system as claimed in claim 9, wherein said means for permitting access to said lock if a driver's breath alcohol content is less than a predetermined level comprises:
means for releasing said latch when said driver's breath alcohol content is less than said predetermined level.

11. The drunk driving prevention system as claimed in claim 10, wherein said means for releasing said latch includes a breath alcohol testing device.

12. The drunk driving prevention system as claimed in claim 6, including means for disabling means for permitting access for a predetermined time said means for releasing said latch if said driver's breath alcohol content is greater than said predetermined level.

13. A drunk driving prevention system, which comprises:
a steering wheel locking device, said steering wheel locking device including:
a first bar including a steering wheel engagement member;
a second bar longitudinally movably mounted with respect to said first bar, said second bar including a steering wheel engagement member; and,
a lock operable to fix said first and second bars longitudinally with respect to each other;
a lock cover movably mounted with respect to said lock, said lock cover being movable between an open position permitting access to said lock and closed position preventing access to said lock;
a latch operable to hold said lock cover in said closed position;
means for releasing said latch;
a breath alcohol measuring device coupled to said means for releasing said latch.
